(19) United States
(12) Patent Application Publication
(10) Pub. No.: US 2022/0414729 A1
(43) Pub. Date: Dec. 29, 2022

(54) Digital Twin Marketplace Takedown Notices And Responses Thereto

(71) Applicant: International Business Machines Corporation, Armonk, NY (US)

(72) Inventor: Lisa Seacat DeLuca, Bozeman, MT (US)

(21) Appl. No.: 17/360,377

(22) Filed: Jun. 28, 2021

(51) Int. Cl. G06Q 30/06; G06Q 30/00; G06Q 50/18

(52) U.S. Cl. CPC G06Q 30/0609; G06Q 30/0185; G06Q 50/184; G06Q 10/105

(57) ABSTRACT

Receiving and responding to takedown requests at a digital marketplace that offers digital twins.

### BACKGROUND

The present invention relates generally to the field of digital twins, and more particularly with digital twins that are characterized, in part, by a manufacturer of the underlying physical asset and by a current end user of the underlying physical asset.

The Wikipedia entry for “digital twin” (as of 3 Jun. 2021) states, in part, as follows: “A digital twin is a virtual representation that serves as the real-time digital counterpart of a physical object or process . . . . The digital twin of a physical object is dependent on the digital thread—the lowest level design and specification for a digital twin—and the ‘twin’ is dependent on the digital thread to maintain accuracy. Changes to product design are implemented using engineering change orders (ECO). An ECO made to a component item will result in a new version of the item's digital thread, and correspondingly to the digital twin . . . . The digital twin concept consists of three distinct parts: the physical product, the digital/virtual product, and connections between the two products. The connections between the physical product and the digital/virtual product is data that flows from the physical product to the digital/virtual product and information that is available from the digital/virtual product to the physical environment . . . . The specific information contained in the digital twins is driven by use cases. The digital twin is a logical construct, meaning that the actual data and information may be contained in other applications . . . . Industry-level dynamics[.] The digital twin is disrupting the entire product lifecycle management (PLM), from design, to manufacturing to service and operations. Nowadays, PLM is very time consuming in terms of efficiency, manufacturing, intelligence, service phases and sustainability in product design. A digital twin can merge the product physical and virtual space. The digital twin enables companies to have a digital footprint of all of their products, from design to development and throughout the entire product life cycle. Broadly speaking, industries with manufacturing business are highly disrupted by digital twins. In the manufacturing process, the digital twin is like a virtual replica of the near-time occurrences in the factory. Thousands of sensors are being placed throughout the physical manufacturing process, all collecting data from different dimensions, such as environmental conditions, behavioral characteristics of the machine and work that is being performed. All this data is continuously communicating and collected by the digital twin . . . . The representation of reality created by digital twins allows manufacturers to evolve towards ex-ante business practices.” (footnotes omitted)

A document published on the internet and entitled “IBM Digital Twin Exchange Provider Terms and Conditions” (as of 6 Jun. 2021) states, in part, as follows: “17. General Each party grants the other only the licenses and rights specified. No other licenses or rights (including licenses or rights under patents) are granted. In the event that IBM receives a notice of copyright infringement concerning the Digital Twins, where the notice conforms to the then current requirements of the Digital Millennium Copyright Act (DMCA), IBM will immediately suspend the Digital Twins listing in the Exchange. In the event IBM takes such action, Provider may provide a counter notice to IBM which conforms to the then current requirements of the DMCA and IBM will, in its sole discretion, restore the Digital Twins to the Exchange. If IBM receives a notice of copyright infringement concerning the material a User stores in the Digital Twin, IBM will refer the notice to the Provider for action. IBM's current policy regarding the DMCA and its requirements can be found at [website address redacted]. In the event the DMCA is amended, IBM will modify the referenced URL to reflect such changes. In the event of a discrepancy between the IBM website and the DMCA, the DMCA will prevail.”

### SUMMARY

According to an aspect of the present invention, there is a method, computer program product and/or system that performs the following operations (not necessarily in the following order): (i) operating a digital twin marketplace including a plurality of digital twins; (ii) receiving, from a manufacturer and by the digital marketplace, a takedown request for a first digital twin of the plurality of digital twins, with the manufacturer being the manufacturer of a physical asset corresponding to the first digital twin; and (iii) taking down the first digital twin from the digital marketplace pursuant to the takedown notice.

According to another aspect, a computer implemented method (CIM) includes: (i) receiving digital twin data set including a plurality of digital twins; (ii) for each given digital twin of the plurality of digital twins, a user of the given digital twin's relationship with a manufacturer company that manufactured a physical asset corresponding to the given digital twin; and (iii) generating a recommendation for changing the end user's experience, vis-à-vis the manufacturer, based on the determined relationship.

### BRIEF DESCRIPTION OF THE DRAWINGS

FIG. 1 is a block diagram of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system; and

FIG. 4 is a flowchart showing a second embodiment method performed, at least in part, by the first embodiment system.

### DETAILED DESCRIPTION

Some embodiments of the present invention are directed to machine logic for determining a user's relationship with a manufacturer (implicitly or explicitly) who is associated with the physical asset for a digital twin resource to change their experience. That experience might be new roles and responsibilities on a frontend given that relationship or lack thereof. A takedown request is just an illustrative example of how an experience might look different for that person versus someone else. Each person has a different level of trust. Each person's answers to questions have a higher weight because it's likely they know more about the asset than would know a typical or representative person. They are the SME (small medium size enterprises). Another example might be prompting that person to provide additional data that a non-OEM (original equipment manufacturer) individual would not be aware of. This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

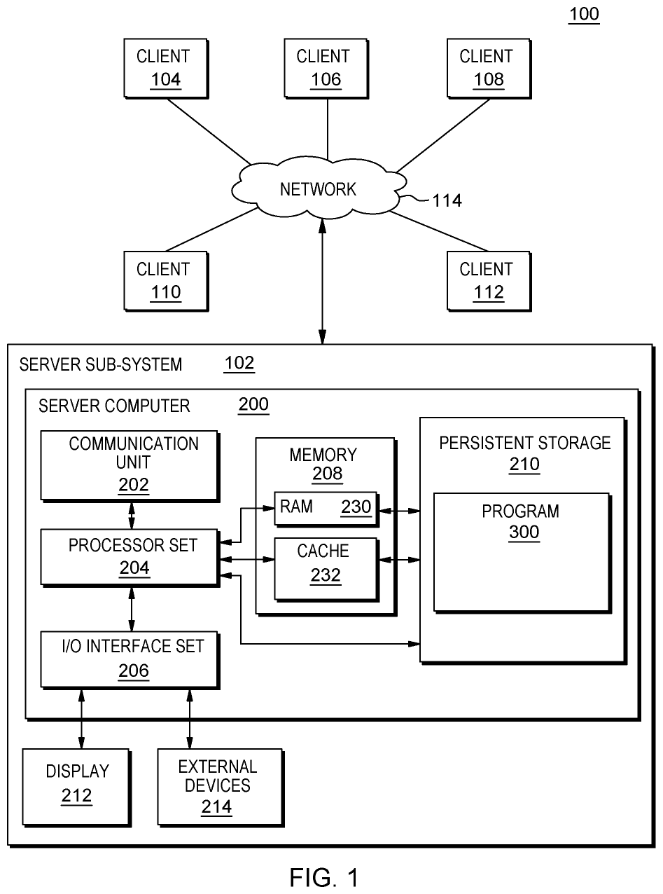

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage, and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications, and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

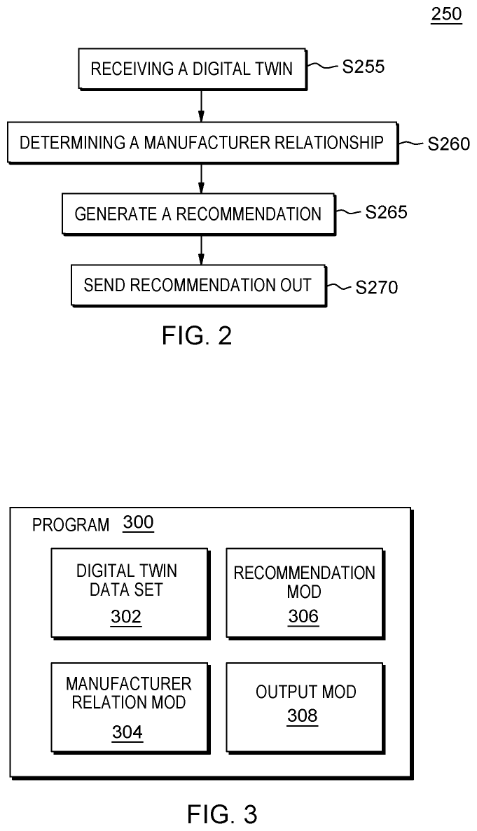

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

Processing begins at operation S255, where digital twin data set 302 is received by program 300 from client sub-system 104 (that is, the computer system of manufacturer company X) through computer network 114. In this example, digital twin data set includes one hundred (100) digital twins, respectively corresponding to the one hundred (100) motor vehicles manufactured by manufacturer company X in the calendar year 2019. These motor vehicles are a type of “physical assets,” and may be referred to, below, as “physical assets.”

Processing proceeds to operation S260, where machine logic of manufacturer relationship module (“mod”) 304 determines, for each digital twin of data set 302: (i) a user's (that is, motor vehicle owner's/driver's) relationship with manufacturer company X; (ii) a relationship between manufacturer company X and retailer seller Y (who bought the motor vehicles from manufacturer company X; and (iii) a relationship between retail seller Y and the end user. These determined relationships may be determined implicitly and/or explicitly. These relationships are determined based upon the digital twins of data set 302.

Processing proceeds to operation S265, where recommendation mod 306 generates a recommendation for changing the end user's experience, vis-à-vis the manufacturer, based on the relationships determined at operation S260. That experience might be new roles and responsibilities on a frontend given that relationship or lack thereof. A takedown request is just an illustrative example of how an experience might look different for that person versus someone else. Each person has a different level of trust. Each person's answers to questions have a higher weight because it's likely they know more about the asset than would know a typical or representative person. They are the SME (small medium size enterprises). Another example might be prompting that person to provide additional data that a non-OEM (original equipment manufacturer) individual would not be aware of.

Processing proceeds to operation S270, where output mod 308 outputs, by an email in human understandable form and format, the recommendation. More specifically, the recommendation generated at operation S265 is communicated through network 114 to the user of client sub-system 106 (in this example, this sub-system is the smart phone of a business executive). The executive has authority to implement the recommendation for changing the experience, and, in this example, she chooses to do just that. In this example, the implementation of the recommendation immensely improves the relationship between manufacturer company X, and end users of the products sold by manufacturing company X.

### III. Further Comments and/or Embodiments

Some embodiments of the present invention recognize one, or more, of the following facts, potential problems and/or potential areas for improvement with respect to the current state of the art: (i) it is desired to stop third parties from uploading content from digital twin marketplaces in any manner that violates copyright or other intellectual property type law; (ii) takedown notices are a known technique for helping to deal with copyright infringement on certain Internet based data exchange platforms; (iii) this copyright infringement can arise innocently (that is, without bad intent on the part of any party involved); and/or (iv) what is needed is a system and method to allow for digital twin take-down requests from OEM's and manufacturers for related digital twin resources.

Some embodiments of the present invention may include one, or more, of the following operations, features, characteristics and/or advantages: (i) digital twin take-down requests for violating intellectual property ownership within the digital twin resources; (ii) allows allowing owners of physical assets associated with a digital twin a way to voice their allegations of IP (intellectual property) infringement concerns on the digital twin resources; and/or (iii) allows manufacturers and OEM's of physical assets that correspond to a digital twin to request the take down of a 3rd parties Digital Twin resources that they believe infringe on their intellectual property rights.

In conjunction with a manufacturing entity causing a new physical asset to be manufactured into existence, a corresponding digital twin is created. The entity that typically has the data of the digital twin entered into a computer system by the manufacturing entity and/or a third party content provider. The digital twin is associated with the physical asset in which it represents. The digital twin includes base information about the asset such as: User/Operating Manuals; Bill of Material; Warranty; Recommended Maintenance Plans/procedures; Specifications; Engineering diagrams; 3D model/CAD drawings; Fault codes; operating manuals; Owner; Change in Ownership; Safety notifications/alerts; Repair procedures; and/or troubleshooting tips.

Some embodiments of the present invention may include one, or more, of the following operations, features, characteristics and/or advantages: (i) within the Digital Twin marketplace/catalog/portal/view, where the digital twins are stored, the first manufacturer user accesses a second digital twin; (ii) the system recognizes that the second digital twin was created by a content provider who is not the manufacturer of the associated physical asset in which the digital twin represents (as determined as explained above); (iii) the system compares the viewing user to determine if the viewing user is associated with the manufacturer of the associated physical asset for the second digital twin; (iv) the comparison mentioned in the foregoing item on this list can be performed by: (a) data in profile—a field indicating the manufacturer/company the user is associated with, (b) email address—ex. bob@company.com is likely an employee at “company”, (c) mining of social data—example lookup on LinkedIn to determine current job title and company association, and (d) APIs for employee lookup within the company; and (v) if the viewing user is associated with the manufacturer of the physical asset associated with the digital twin: (a) include an option to request IP infringement be investigated, and (b) notification that potential infringement may be possible given the digital twin was created by a third party content provider.

In some embodiments, if the manufacturing user requests an IP investigation then: (i) team review the request and comply with Digital Millennium Copyright Act requirements to take down within 24 hours of a complaint; (ii) the third party content provider would be alerted of the take-down request; (iii) the digital twin resource within the marketplace/catalog will be removed from the searchable results and placed in a private/draft state until the review completes; (iv) optionally, a chat or dialog could be initiated to review the request and allow the two parties to go through a mitigation discussion to overcome any IP concerns; (v) once the manufacturer agrees any IP concerns are no longer valid; (vi) the manufacturing user may choose to re-instate the digital twin within the marketplace/catalog; and (vii) an optional icon may be used to show the digital twin has passed manufacturing IP verification.

An example of a method according to the present invention will now be set forth in the following paragraphs.

DIGITAL TWIN UPLOAD OPERATION: Able is a digital specialist for Baker Co.

Able causes her computer to upload Digital Twin resources into a repository of digital twins that is made navigable by a catalog of digital twins that are in the repository. Because Able works for Baker Co., these entries are clearly tagged as being created by Baker Co. (which is the Manufacturer in this example).

DISCOVERY OF POTENTIALLY INFRINGING TWIN: While reviewing her listings, Able scrolls down and notices more listings from two (2) third parties). She is pleasantly surprised to see an ecosystem of growing content such as forecasting models and inventory recommendations for the associated Baker Co. physical asset. However, two entries stand out as being potentially infringing on Baker Co.'s intellectual property, such as copyright type rights in the two (2) potentially infringing digital twins.

TAKEDOWN REQUEST: Able uses the Digital Marketplace to submit two (2) takedown requests—one for each of the potentially infringing digital twins that are currently available in the repository.

DIGITAL MARKETPLACE RESPONDS: The Digital Marketplace performs several actions in response to the takedown request: (i) determines that copyright in the physical asset(s) underlying the two potentially infringing digital twins are owned by Baker Co.; (ii) determines the takedown request originated with a representative of Baker Co. (that is, Able); (iii) determines that the third party offering the two potentially infringing digital twins for sale does not represent the manufacturer (that is, in this example, Baker); and (iv) takes down, at least temporarily, the two potentially infringing digital twins.

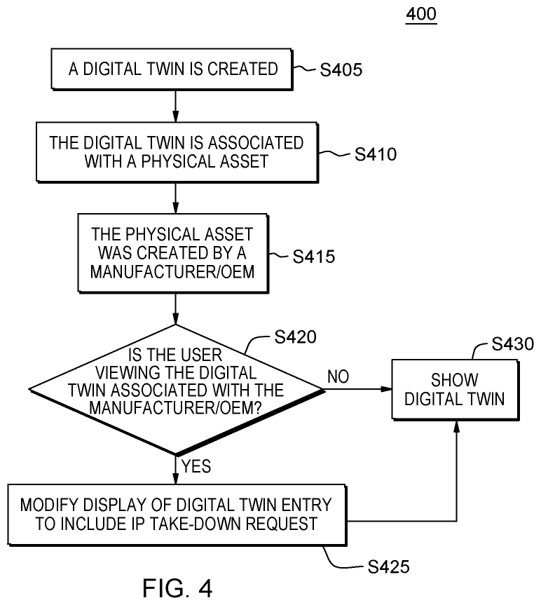

As shown in flowchart 400 of FIG. 4, a method according to an embodiment of the present invention includes the following operations (with the process flow among and between the various operations being as shown by arrows in FIGS. 4): S405, S410, S415, S420, S425, and S430.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Set of thing(s): does not include the null set; “set of thing(s)” means that there exist at least one of the thing, and possibly more; for example, a set of computer(s) means at least one computer and possibly more.

Virtualized computing environments (VCEs): VCEs can be stored as “images.” A new active instance of the VCE can be instantiated from the image. Two types of VCEs are virtual machines and containers. A container is a VCE that uses operating-system-level virtualization. This refers to an operating system feature in which the kernel allows the existence of multiple isolated user-space instances, called containers. This isolated user-space instances may look like real computers from the point of view of programs running in them. A computer program running on an ordinary operating system can see all resources (connected devices, files and folders, network shares, CPU power, quantifiable hardware capabilities) of that computer. However, programs running inside a container can only see the container's contents and devices assigned to the container.

Cloud computing system: a computer system that is distributed over the geographical range of a communication network(s), where the computing work and/or computing resources on the server side are primarily (or entirely) implemented by VCEs (see definition of VCEs in previous paragraph). Cloud computing systems typically include a cloud orchestration module, layer and/or program that manages and controls the VCEs on the server side with respect to instantiations, configurations, movements between physical host devices, terminations of previously active VCEs and the like.

What is claimed is:

1. A computer-implemented method (CIM) comprising:
operating a digital twin marketplace including a plurality of digital twins;
receiving, from a manufacturer and by the digital marketplace, a takedown request for a first digital twin of the plurality of digital twins, with the manufacturer being the manufacturer of a physical asset corresponding to the first digital twin; and
taking down the first digital twin from the digital marketplace pursuant to the takedown notice.

2. The CIM of claim 1 further comprising:
determining potential copyright infringement in the physical asset manufactured by the manufacturer.

3. The CIM of claim 1 further comprising:
verifying that the takedown request was communicated by the manufacturer or the manufacturer's duly authorized agent.

4. The CIM of claim 1 further comprising:
resolving issues relevant to the takedown request.

5. The CIM of claim 4 further comprising:
responsive to the resolution, putting the first digital twin back in the digital marketplace.

6. A computer program product (CPP) comprising:
a set of storage device(s); and
computer code stored collectively in the set of storage device(s), with the computer code including data and instructions to cause a processor(s) set to perform at least the following operations:
operating a digital twin marketplace including a plurality of digital twins;
receiving, from a manufacturer and by the digital marketplace, a takedown request for a first digital twin of the plurality of digital twins, with the manufacturer being the manufacturer of a physical asset corresponding to the first digital twin; and
taking down the first digital twin from the digital marketplace pursuant to the takedown notice.

7. The CPP of claim 6 further comprising instructions and data for:
determining potential copyright infringement in the physical asset manufactured by the manufacturer.

8. The CPP of claim 6 further comprising instructions and data for:
verifying that the takedown request was communicated by the manufacturer or the manufacturer's duly authorized agent.

9. The CPP of claim 6 further comprising instructions and data for:
resolving issues relevant to the takedown request.

10. The CPP of claim 9 further comprising instructions and data for:
responsive to the resolution, putting the first digital twin back in the digital marketplace.

11. The CPP of claim 6 wherein the CPP is in the form of a computer system, with the CPP further comprising the processor(s) set.

12. A computer implemented method (CIM) comprising:
receiving digital twin data set including a plurality of digital twins;
for each given digital twin of the plurality of digital twins, a user of the given digital twin's relationship with a manufacturer company that manufactured a physical asset corresponding to the given digital twin; and
generating a recommendation for changing the end user's experience, vis-à-vis the manufacturer, based on the determined relationship.

13. The CIM of claim 12 further comprising:
outputting the recommendation.
